(19) United States
(12) Patent Application Publication
(10) Pub. No.: US 2013/0169958 A1
(43) Pub. Date: Jul. 4, 2013

(54) Surface Processing Progress Monitoring System

(71) Applicant: SHIMADZU CORPORATION, Kyoto-shi (JP)

(72) Inventors: Hiroomi GOTO, Nara-shi (JP); Yuzo NAGUMO, Kizugawa-shi (JP); Rui KATO, Kyoto-shi (JP)

(73) Assignee: SHIMADZU CORPORATION, Kyoto-shi (JP)

(21) Appl. No.: 13/707,407

(22) Filed: Dec. 6, 2012

(30) Foreign Application Priority Data
Dec. 6, 2011 (JP) 2011-266613

(51) Int. Cl. G01B 11/14

(52) U.S. Cl. CPC G01B 11/14
USPC 356/300

(57) ABSTRACT

Provided is a technique for calculating a hole depth or substrate thickness with high accuracy during surface processing work, such as etching or grinding. A difference spectrum calculator calculates the difference between a spectrum acquired at one time and another spectrum acquired at a time earlier than the aforementioned time by a predetermined. The base spectra which are contained in the observed spectra but do not contribute to interference can be regarded as common to the observed spectra. Therefore, the difference spectrum is a virtually normalized interference spectrum. A Fourier transform operator performs a frequency analysis on the difference spectrum, using a Fourier transform or similar technique. In the thereby obtained signal, a clear peak originating from the interference appears at a position corresponding to the optical path length. From this peak position, an optical distance calculator determines the optical path length, calculates the hole depth, and displays the calculated result.

### TECHNICAL FIELD

The present invention relates to a surface processing progress monitoring system for measuring, in almost real time, the depth or level difference of a micro hole (e.g. through silicon via: TSV) when such a hole is being formed on a semiconductor substrate or similar material by any type of etching process, or the thickness of a substrate, crystal body or other material from when its surface is being removed by a grinding process.

### BACKGROUND ART

In the process of producing semiconductor integrated circuits, an etching process using low-pressure plasma or a similar gas is performed to form micro-sized holes or grooves in a semiconductor substrate, such as a silicon wafer. In normal etching procedures, a resist film for masking the areas where no hole or groove should be created is initially formed on the substrate before the etching process. During the etching process, the areas where no resist mask is present are selectively etched. After this process is completed, the resist film is removed to obtain a substrate having holes or grooves in arbitrary forms. The depth of the hole or groove created in this manner depends on various conditions, such as the etching time, the kind of gas and the gas pressure. To create a hole or groove with an intended depth, its actual depth is monitored during the process to perform various controls, such as determining the ending point of the etching or regulating the processing conditions.

Various techniques have been conventionally proposed for optical measurements of the depth or level difference of a micro hole formed by etching, the thickness of a thin layer removed by etching, or the thickness of a substrate or crystal body whose surface is gradually removed by grinding, polishing or other processes. Examples are as follows:

Each of Patent Documents 1-3 discloses a system for performing a spectrometric measurement of an interference light resulting from the interference of light reflected from the bottom of a hole or groove (which is the measurement target) and light reflected from an area around the hole or the upper edge of the groove, or an interference light resulting from the interference of light reflected from the substrate surface (which is the measurement target) and light reflected from the bottom surface of the substrate, to obtain an interference spectrum data, for performing a fitting on the spectrum to analyze its interference pattern, and for computing the depth of the hole or groove, or the thickness of a substrate or thin layer, based on the interference pattern.

Patent Document 4 discloses the technique of performing a spectrometric measurement of an interference light resulting from the interference of two lights respectively reflected by the two surfaces of a thin layer (which is the measurement target) to obtain an interference spectrum data, and performing a Fourier transform on the spectrum to compute the thickness of the layer.

Each of Patent Documents 5 and 6 discloses the technique of applying temporal differentiation to an interference spectrum obtained by a spectrometric measurement and comparing the computed time-derivative spectrum with a reference spectrum previously obtained under desired processing conditions, to check the progress of the process.

Any of the aforementioned conventional techniques includes the steps of performing a spectrometric measurement of interference light from the measurement target to obtain an interference spectrum and performing a certain kind of data processing or calculation on that spectrum to obtain a result of interest. A spectrum obtained by a spectrometric measurement normally contains not only the spectral interference pattern originating from the target structure but also other wavelength characteristics due to various factors. Therefore, among the aforementioned techniques, those which use a fitting or frequency analysis based on the interference spectrum require the step of extracting, from the obtained spectrum, only the spectral interference pattern originating from the target structure.

For example, consider the case where two lights, denoted by F_{A} and F_{B}, are respectively reflected by two planes A and B due to the thickness d of a thin layer (or the depth of an etched hole, etc) which is the target structure. Provided that Ref(λ) denotes the spectral intensity distribution that does not contribute the interference, the spectra of F_{A} and F_{B} are respectively expressed as follows:

F_{A}(λ)=A_{A}·√{Ref(λ)·exp(kx−ωt+2d/λ·2π)} (1), and

F_{B}(λ)=A_{B}·√{Ref(λ)·exp(kx−ωt+0)} (2),

where A_{A} and A_{B} are the amplitudes of the reflected lights F_{A} and F_{B}, respectively. The interference pattern obtained by the spectrometric measurement is a composite wave of the two reflected lights F_{A} and F_{B}, and its spectrum F(λ) is expressed as follows:

F(λ)=|F_{A}(λ)+F_{B}(λ)|²=Ref(λ){A_{A}²+A_{B}²+2A_{A}A_{B} cos(2d/λ·2π)} (3).

In a frequency analysis by Fourier transform, it is generally necessary to extract the cosine-wave component from the interference pattern (equation (3)), which requires a normalization process expressed as F(λ)−(A_{A}²+A_{B}²)Ref(λ). Normally, in this normalization process, an emission spectrum of a known light source is used as the spectrum distribution Ref(λ) that does not contribute to the interference. However, the shape and magnitude of Ref(λ) in an actually observed spectrum undergoes various kinds of aberrations or distortions of the optical system, and consequently, becomes different from the distribution of the emission spectrum of the light source. Therefore, it is difficult to uniquely determine the spectrum distribution. Estimation of the base spectrum Ref(λ) which does not contain the concerned interference pattern in a spectrum received by a measurement system is also very difficult, because the spectrum is affected by interference, scattering, absorption and other effects caused by other structures which are not the target of etching (or grinding), such as another multi-layer structure or a previously created pattern on the substrate.

The accuracy of an analyzing technique based on the spectral interference pattern is significantly affected by the normalization process in any case of using the fitting, maximum/minimum wavelength detection, or frequency analysis. Therefore, to ensure high measurement accuracy, it is essential to correctly determine, for the used measurement system, the base spectrum Ref(λ) in which no influence of the spectrum of the interference pattern is noticeable. However, in practice, it is difficult to determine the correct base spectrum Ref(λ), and therefore, there is a limit on the accurate calculation of the value to be measured, such as the depth of a hole or step, or the thickness of a thin layer or substrate.

### BACKGROUND ART DOCUMENT

### Patent Document

Patent Document 1: JP-A H11-274259
Patent Document 2: JP-A 2004-507070
Patent Document 3: JP-A 2004-253516
Patent Document 4: JP-A 2005-184013
Patent Document 5: JP-A 2002-81917
Patent Document 6: JP-A 2008-218898

### SUMMARY OF THE INVENTION

### Problem to be Solved by the Invention

The present invention has been developed to solve the previously described problem, and its primary objective is to provide a surface processing progress monitoring system capable of measuring the depth or level difference of an etched hole or the thickness of a thin layer or substrate with high accuracy and in a short period of time, based on a spectrum obtained by a spectrometric measurement, without using the base spectrum Ref(λ) which is difficult to accurately determine.

### Means for Solving the Problems

In a measurement optical system including a structure chosen as the target structure (such as a hole or step formed on a substrate, a thin film, or a substrate itself), although the optical path length changes as a result of the surface processing, such as etching or grinding, the distortion of the spectrum or the state of interference due to other structures does not change in a short period of time. This means that, if one interference spectrum is acquired at one point in time and compared with another interference spectrum previously acquired at a point in time earlier than the aforementioned point in time by a sufficiently short length of time, their base spectra Ref(λ), which do not contribute to the interference, can be regarded as unchanged because the two spectra have been acquired by the same measurement optical system and with only a slight difference (shift) in the acquisition time. Accordingly, by calculating the difference between two interference spectra respectively obtained at two different points in time at a sufficiently short interval of time, it is possible to extract a cosine-wave component representing an interference pattern, without performing a normalization process.

Based on this knowledge, the present inventors have conceived the idea of using, in place of the base spectrum Ref(λ), an interference waveform obtained at a point in time earlier than the current point in time by a predetermined length of time, as a reference waveform to determine a real spectrum of an interference pattern, and then performing a frequency analysis on this spectrum to compute a hole depth, film thickness or the like.

Thus, the first aspect of the present invention aimed at solving the aforementioned problem provides a surface processing progress monitoring system for measuring the size of a target structure, such as the depth or level difference of a hole or groove formed on a substrate by surface processing work, or the thickness of a thin layer or substrate increasing or decreasing due to the surface processing work, including a light source for generating a measurement light having a predetermined wavelength width, an interference optical system for producing interference of two lights respectively reflected by a first portion and a second portion of the target structure, a dispersing device for wavelength-dispersing the interference light produced by the interference optical system, and a detector for detecting, for each wavelength, the wavelength-dispersed light produced by the dispersing device, the surface processing progress monitoring system further including:

a) a spectrum acquiring section for acquiring, by the detector, two spectra of a predetermined wavelength range at two points in time separated by a short interval of time;

b) a difference spectrum calculating section for calculating the difference spectrum of the two spectra obtained by the spectrum acquiring section; and

c) a frequency analyzing section for performing a frequency analysis on the difference spectrum to calculate an interference distance of interest, and for determining the size of the target structure from the interference distance.

Typical examples of the surface processing work in the first aspect of the present invention (and the second aspect thereof, which will be described later) include: creation of a hole or groove by etching (including both dry etching and wet etching), removal of a surface layer by grinding or polishing (including both the chemical and mechanical types of grinding or polishing), and formation of a thin layer by chemical vapor deposition (CVD) or other processes.

If the target structure is a substrate, the first and second portions are the obverse and reverse surfaces of the substrate. If the target structure is a thin layer formed on a substrate, the first and second portions are the upper and lower surfaces of the thin layer. If the target structure is a hole or groove formed on the surface of a substrate, the first portion is the bottom surface of the hole or groove, and the second portion is the surrounding area of the hole or the surface of the upper edge of the groove.

In the surface processing progress monitoring system according to the first aspect of the present invention, when a spectrum obtained at time t₀ is denoted by F₀(λ) and another spectrum obtained at time t₁, which is earlier than t₀ by Δt, is denoted by F_{I}(λ) (where Δt is such a short period of time that the change Δd in the optical distance to the target structure does not exceed one wavelength of the measurement light), these spectra are respectively expressed as follows:

F₀(λ)=Ref(λ){A_{A}²+A_{B}²+2A_{A}A_{B} cos(2d/λ·2π)} (4), and

F₁(λ)=Ref(λ){A_{A}²+A_{B}²+2A_{A}A_{B} cos(2[d−Δd]/λ·2π)} (5).

The difference spectrum of these two spectra is expressed as follows:

F₀₋₁(λ)=4Ref(λ)A_{A}A_{B} sin(2πΔd/λ)cos {(4πd/λ)−(2πΔd/λ)+(π/2)} (6).

If Δd is sufficiently small and the wavelength width of the measurement light is sufficiently narrow, Δd/λ can be considered to be constant. That is to say, the following equation can be derived by substituting Δd/λ=Δd/λ_{c} into equation (6):

F₀₋₁(λ)=4Ref(λ)A_{A}A_{B} sin(2πΔd/λ_{c})cos {(4πd/λ)−(2πΔd/λ_{c})+(π/2)} (7).

A comparison of equations (7) with (4) shows that both the difference spectrum F₀₋₁(λ) and the spectrum F₀(λ) obtained at time t₀ have the same frequency value, i.e. 4πd/λ. This means that equation (7) contains an interference pattern whose frequency is the same as contained in equation (4). Therefore, it is possible to determine the depth d of an etched hole (or the thickness of a thin film) by a frequency analysis of equation (7).

The amplitude detected by equation (7) is 4Ref(λ)A_{A}A_{B} sin(2πΔd/λ_{c}). If the data acquisition is made with a temporal difference that makes the change Δd in the optical path length equal to one fourth of the measurement wavelength λ_{c}, the amplitude of the interference waves will be 4Ref(λ)A_{A}A_{B}, which is two times the amplitude of the original interference pattern (as compared to equation (4)). Thus, a high level of sensitivity can be achieved.

In the surface processing progress monitoring system according to the first aspect of the present invention, various kinds of commonly known techniques can be used for the frequency analysis of the difference spectrum. Specific examples include a Fourier transform operation and an analysis by the maximum entropy method.

Normally, frequency analysis leaves some room for ambiguity determined by the reciprocal of the width of the peak on the observed spectrum, and therefore, cannot achieve sufficient accuracy in estimating the frequency of the interference pattern. This problem can be solved by using the phase 4πd/λ−2πΔd/λ_{c} of the interference pattern in the difference spectrum expressed as equation (7). For example, consider the case of detecting a zero-crossing point (a wavelength at which the interference amplitude becomes zero) by using the aforementioned phase. In this case, since sin(4πd/λ−2πΔd/λ_{c})=0, the optical path length d can be more accurately estimated by the following equation:

d=λ/4(2Δd/λ_{c}+k) (8),

where k is an integer.

Thus, the second aspect of the present invention aimed at solving the aforementioned problem provides a surface processing progress monitoring system for measuring the size of a target structure, such as the depth or level difference of a hole or groove formed on a substrate by surface processing work, or the thickness of a thin layer or substrate increasing or decreasing due to the surface processing work, including a light source for generating a measurement light having a predetermined wavelength width, an interference optical system for producing interference of two lights respectively reflected by a first portion and a second portion of the target structure, a dispersing device for wavelength-dispersing the interference light produced by the interference optical system, and a detector for detecting, for each wavelength, the wavelength-dispersed light produced by the dispersing device, the surface processing progress monitoring system further including:

a) a spectrum acquiring section for acquiring, by the detector, two spectra of a predetermined wavelength range at two points in time separated by a short interval of time;

b) a difference spectrum calculating section for calculating the difference spectrum of the two spectra obtained by the spectrum acquiring section; and

c) a phase analyzing section for detecting a phase of an interference pattern based on the difference spectrum, for calculating an interference distance of interest from the phase, and for determining the size of the target structure from the interference distance.

As noted previously, the temporal difference with which to acquire two spectra must be such a short period of time that the change Δd in the optical distance to the target structure does not exceed one wavelength of the measurement light. However, too short a temporal difference results in too small a change Δd in the optical distance, making the measurement meaningless. In order to automatically set this temporal difference at an appropriate value, the surface processing progress monitoring system according to one preferable mode of the first or second aspect of the present invention further includes an acquisition condition determining section for determining and setting an optimal value of the aforementioned short interval of time based on the magnitude of the amplitude of the difference spectrum. Alternatively, the system may further include an acquisition condition determining section for determining and setting an optimal value of the aforementioned short interval of time based on the area of a region surrounded by the curve of the difference spectrum or on the change in the amplitude of the spectra.

### Effect of the Invention

By the surface processing progress monitoring system according to the first or second aspect of the present invention, an interference pattern indicating the depth of an etched hole, the thickness of a thin layer, substrate or similar target structure can be accurately extracted from an observed spectrum containing the interference, without being affected by the spectral distortion due to the temporal change of the light source, the spectral distortion due to the temporal change of a measurement optical system, or by the spectral distortion due to interference or scattering of light originating from a structure present on the substrate being measured that is not related to the processing work, such as etching, grinding or polishing. Based on the extracted interference pattern, it is possible to measure correctly, and with high spatial resolution, the depth or level difference of a hole in question being formed by etching, the thickness of a substrate or thin film which changes as a result of grinding or polishing, or other kinds of structural quantities. The computing process for calculating the size of the target structure, such as the hole depth, is so simple and requires such a short period of time that the measurement can be performed on a highly real-time basis. Such a system is also suitable for various controls, such as the end-point detection of the etching or grinding or the condition change of the process.

### BRIEF DESCRIPTION OF THE DRAWINGS

FIG. 1 is a schematic configuration diagram of a surface processing progress monitoring system according to one embodiment of the present invention.

FIGS. 2A and 2B are model diagrams showing how reflections take place when measuring a hole depth (FIG. 2A) or substrate thickness (FIG. 2B) by the surface processing progress monitoring system of the present embodiment.

FIG. 3 is a flowchart showing the measuring operations by the surface processing progress monitoring system of the present embodiment.

FIG. 4 is a schematic timing chart showing the timing of each of the measuring operations shown in FIG. 3.

FIG. 5 shows one example of the acquisition and processing of spectra in the surface processing progress monitoring system of the present embodiment.

FIG. 6 shows one example of the measurement in which an interference pattern due to a structure that is not being ground has been cancelled by the acquisition and processing of spectra in the surface processing progress monitoring system of the present embodiment.

### BEST MODE FOR CARRYING OUT THE INVENTION

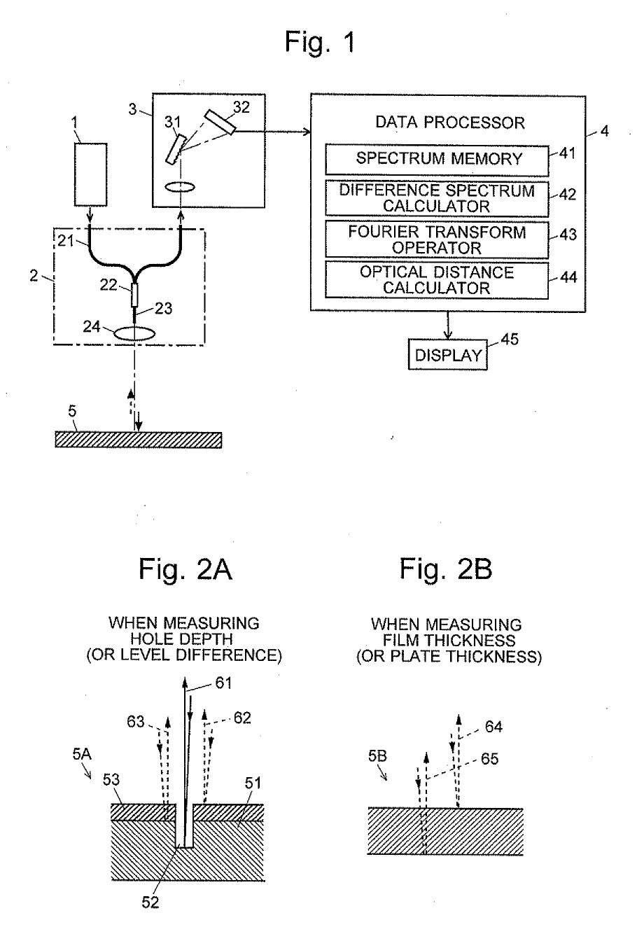

A surface processing progress monitoring system according to one embodiment of the present invention is hereinafter described with reference to the attached drawings. FIG. 1 is a schematic configuration diagram of a surface processing progress monitoring system of the present embodiment. FIGS. 2A and 2B are model diagrams showing how reflections take place when measuring a hole depth (FIG. 2A) or substrate thickness (FIG. 2B).

The present surface processing progress monitoring system is used for monitoring a continuously changing distance to a sample 5, like the substrate thickness of the sample 5 or the depth of a trench formed in the sample 5 being processed by a plasma etching system or a substrate grinding system. This system includes a light source 1, a measurement optical system 3, a light-dispersing unit 3 and a data processor 4. The light source 1 and the measurement optical system 2, as well as the measurement optical system 2 and the light-dispersing unit 3, are connected via optical fibers.

For example, the light source 1 for the measurement may be a super luminescent diode (SLD) having a central wavelength of 830 nm and a full width at half maximum of 15 nm, or any other type of light source whose wavelength width is approximate to the aforementioned value. Abeam of measurement light generated from the light source 1 is introduced into the entrance optical fiber 21. After passing through a fiber coupler 22, the light propagates through the optical fiber 23, to be eventually emitted from the tip of the optical fiber 23 into the space. The light emitted from the end of the optical fiber 23 is cast onto the sample 5 through a collimator lens 24.

Examples of the interferences that occur in the target structure in the sample 5 are hereinafter described by means of FIGS. 2A and 28. When, as shown in FIG. 2B, the measurement target is the thickness of a substrate 513 being ground, the light 64 reflected by the obverse surface of the substrate 5B interferes with the light 65 reflected by the reverse surface thereof, which originates from the light penetrating the substrate 513. When, as shown in FIG. 2A, the measurement target is the depth of a trench being etched, the interference primarily occurs between the light 62 reflected by the obverse surface of the resist layer 53 on the substrate 51, the light 63 reflected by the obverse surface 51 of the substrate, which originates from the light penetrating the resist layer 53, and the light 61 reflected by the bottom surface of the trench hole 52 being etched. These reflected lights 61-63 or 64-65 pass through the collimator lens 24 in the direction opposite to the previous direction of casting the light onto the sample 5, and enter the optical fiber 23. Then, after passing through the fiber coupler 22, the lights reach the light-dispersing unit 3. While passing through the optical fiber 23, these lights sufficiently interfere with each other, to be interference light before reaching the light-dispersing unit 3.

In the light-dispersing unit 3, the interference light is dispersed into wavelengths by a diffraction grating 31 or similar dispersing element. These components of light having different wavelengths are simultaneously detected by an array detector 32, such as a CCD line sensor. The array detector 32 produces detection signals respectively corresponding to the different wavelengths. The obtained signals are sent to the data processor 4, which includes, as its functional blocks, a spectrum memory 41, a difference spectrum calculator 42, a Fourier transform operator 43 and an optical distance calculator 44. As will be described later, the data processor 4 processes those signals to compute the thickness of a substrate 513 being ground, the depth of a trench hole 52 being etched, or the like. The calculated result is shown on a display unit 45 to the observers.

The data processor 4 is actually a personal computer with a previously installed data processing software program. Executing this program enables the computer to function as the data processor 4.

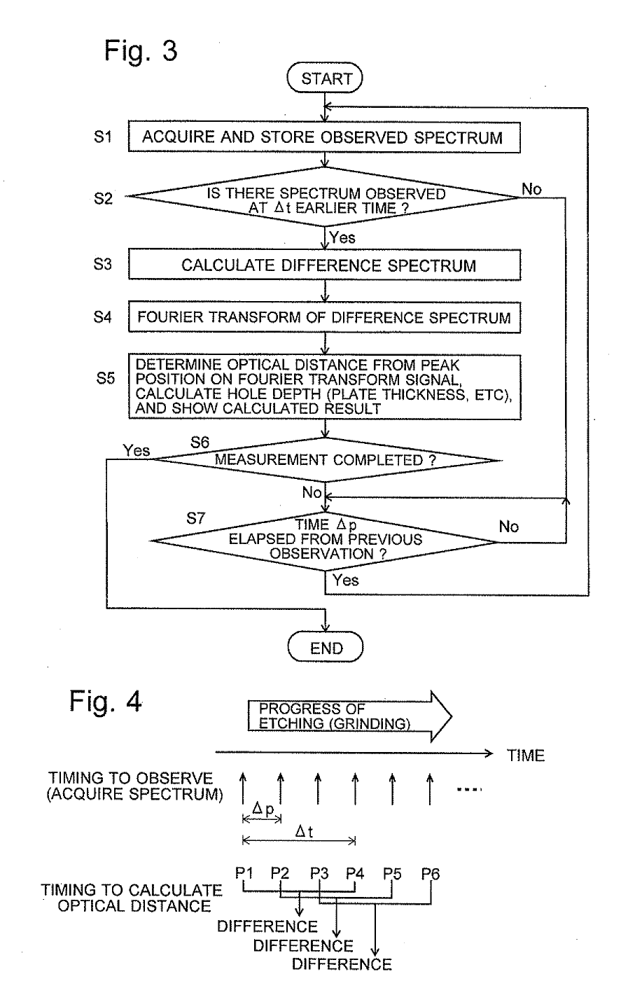

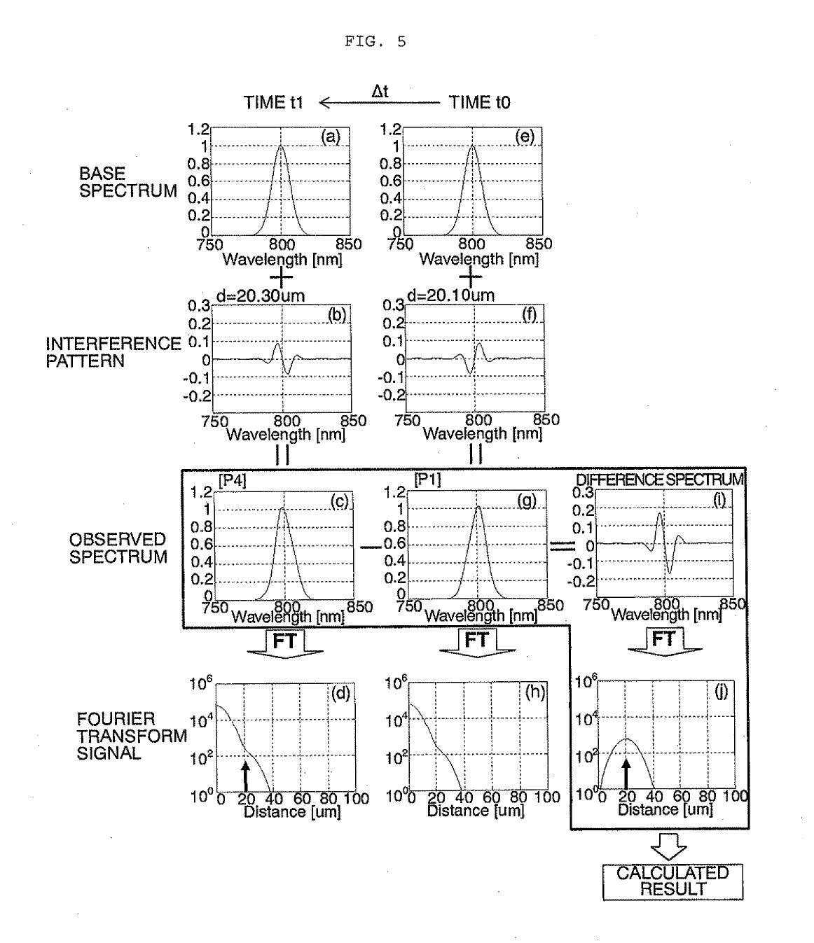

An operation of the surface processing progress monitoring system of the present embodiment is hereinafter described by means of FIGS. 3-5, primarily focusing on the data processing performed by the data processor 4 characteristic of the present system. FIG. 3 is a flowchart showing the measuring operations by the surface processing progress monitoring system of the present embodiment. FIG. 4 is a schematic timing chart showing the timing of each of the operations. FIG. 5 shows one example of the acquisition and processing of spectra. The example shown in FIG. 5 is the result of an experiment in which the depth of a trench hole was measured using a light source 1 having a central wavelength of 800 nm and a full width at half maximum (FWHM) of 15 nm. Accordingly, the following description illustrates the case of measuring the depth of a trench hole created by etching. However, the same description is applicable to the case of measuring the thickness of a substrate or thin layer.

For example, when the measurement of the hole depth is initiated simultaneously with the beginning of etching, the data processor 4 acquires spectrum data covering a predetermined wavelength range obtained by the array detector 32 of the light-dispersing unit 3 at a predetermined point in time, and stores the data in the spectrum memory 41 (Step S1). The spectrum data is repeatedly acquired at predetermined intervals of time Δp by Steps S1 and S7 until it is determined in Step S6 that the measurement has been completed. In the present example, Δp is set at one third of Δt, which will be mentioned later, However, its value is not limited to this example.

After a spectrum data is acquired in Step S1, the difference spectrum calculator 42 determines whether or not a spectrum data obtained at a point in time earlier than the current point in time by Δt is stored in the spectrum memory 41 (Step S2). If no such data is stored, the optical distance calculation process (which will be described later) cannot be performed, so that the operation proceeds to Step S7. As the acquisition and storage of spectrum data are repeated at intervals of Δp as shown in FIG. 4, the result of determination in Step S2 becomes “Yes” at a certain point in time. Suppose that a spectrum data P1 was acquired at time t0 and another spectrum data P4 was acquired at time t1 after the lapse of Δt from t0. The observed spectrum obtained at time t1 (graph (c) of FIG. 5) resulted from the superposition of a reflection spectrum containing no interference (the base spectrum; graph (a) of FIG. 5) and a spectral interference pattern (graph (b) of FIG. 5) created by interference due to the trench hole 52 (the measurement target).

Conventional methods generally include the steps of performing a frequency analysis of this observed spectrum using, for example, a Fourier transform (FT) operation to obtain a signal as shown in graph (d) of FIG. 5 (such a signal is hereinafter called the “Fourier transform signal”), and determining the positions of the peaks on this signal to estimate the optical path length which has caused the interference. Graph (c) of FIG. 5 shows a spectrum obtained by measuring an optical path length of d=20.3 μm, and graph (d) of FIG. 5 shows the corresponding Fourier transform signal. In this graph, although a signal exists at the position of d=20.3 μm, it is difficult to pinpoint the peak position (indicated by the arrow) because the signal to be analyzed is hidden by the bias signal located on the side closer to d=0 μm. Ideally, it is desirable to subtract the base spectrum (graph (a) of FIG. 5), i.e. the spectrum which does not contribute to the interference, from the observed spectrum shown in graph (c) of FIG. 5 in advance of the Fourier transform. However, as already noted, estimating the correct shape and magnitude of the base spectrum for each measurement is very difficult since the shape of the base spectrum is affected by various distortions of the measurement optical system, the reflectivity of the sample and other factors. This means that it is impossible to subtract an appropriate base spectrum from the observed spectrum, and therefore, it is difficult to locate the peaks in the Fourier transform signal with sufficient accuracy.

By contrast, the technique adopted in the present embodiment does not use the base spectrum as the reference waveform, but an interference waveform obtained at a point in time earlier than the current point in time by a predetermined length of time. In the present example, the observed spectrum P1 acquired at time t0, which is earlier than time t1 by Δt, is stored in the spectrum memory 41, and this spectrum can be used as the reference waveform. The length of time Δt is set to be so short that the change Δd in the optical distance of the target structure does not exceed the wavelength of the measurement light. The observed spectrum acquired at time t0 is shown in graph (g) of FIG. 5. (This spectrum was obtained when the hole depth was d=20.1 μm, i.e. before the etching progressed by 200 nm.) This observed spectrum also resulted from the superposition of a reflection spectrum containing no interference (the base spectrum; graph (e) of FIG. 5) and a spectral interference pattern (graph (f) of FIG. 5) created by interference due to the trench hole 52 (the measurement target).

If the temporal difference Δt between t1 and t0 is sufficiently short, the change in the base spectrum is negligible. Accordingly, the difference spectrum calculator 42 subtracts the spectrum data P1 obtained at time t0 from the spectrum data P4 obtained at t1 (Step S3). By this subtraction, the approximately identical base spectra contained in the two observed spectra are cancelled, which means that this operation is effectively equivalent to the subtraction between two interference patterns of the same frequency with different phases (graphs (b) and (f) of FIG. 5) and yields, as the difference spectrum, an interference pattern which also has the same frequency. This difference spectrum is a virtually normalized interference spectrum with no base spectrum contained therein. Accordingly, the Fourier transform operator 43 performs a frequency analysis on the difference spectrum by a Fourier transform to obtain a Fourier transform signal as shown in graph (j) of FIG. 5 (Step S4).

Unlike the signal shown in graph (d) of FIG. 5, this Fourier transform signal contains no bias signal. Therefore, the peaks clearly appear on this signal and their positions can be easily estimated. The optical distance calculator 44 determines the peak positions on the Fourier transform signal derived from the difference spectrum, and calculates the optical path length which has caused the interference. Then, from this optical path length, it calculates the size of the measurement target, i.e. the depth of the trench hole or the thickness of the substrate, and displays the result on the display unit 45 (Step S5). In the case of graph (j) of FIG. 5, the peak position indicates that the difference in the optical path length is 20 μm.

After the hole depth is thus determined, the operation proceeds to Step S6. If the measurement is not completed, the operation further proceeds to Step S7, where a new spectrum, which changes with the progress of the etching, is acquired. Every time a new spectrum is acquired, a difference spectrum between the new spectrum and a spectrum obtained at a point in time earlier than the current point in time by Δt is created (see FIG. 4). From this new difference spectrum, the optical path length corresponding to the depth of the trench hole is calculated. Accordingly, every time a new spectrum is acquired, the latest depth of the trench hole at that point in time can be calculated and shown on the display unit 45.

As already explained, the temporal difference Δt between the two spectra used for calculating the difference spectrum must be such a short period of time that the change Δd in the optical distance to the target structure does not exceed the wavelength of the measurement light. Its value may be previously determined. However, in some cases it is difficult to determine an appropriate value of Δt, e.g. when the etching rate (the grinding rate or the like) is unknown. Using an inappropriate value of Δt may possibly result in too small a waveform of the difference spectrum representing the interference pattern. To address such problems, it is preferable to adaptively determine Δt from the obtained difference spectrum rather than to set it beforehand.

For example, in the previous case, not only the spectrum P3 but also P4 or P5 (or even P2 or foregoing spectra in some cases) can also be chosen as the reference waveform for the observed spectrum P6. Accordingly, it is possible to calculate the difference spectrum for each of the three combinations of P6−P5, P6−P4 and P6−P3, for example, and compare the magnitudes of the amplitudes of the obtained difference spectra to select the best combination and perform a frequency analysis on the selected difference spectrum. In this case, the best combination may be chosen based not only on the amplitude of the waves (interference pattern) observed on the difference spectrum, but also on the area surrounded by the curve of the waveform appearing on the difference spectrum or on the change in the amplitude of the spectra. It should be noted that, when the rate of etching (or grinding, etc) is constant, the optimal value of Δt will never change in the middle of the process. Therefore, once an optimal value of Δt is determined in the previously described manner, the same value of Δt can be used throughout the process to calculate the difference spectrum.

In the previous embodiment, the optical path length resulting from the interference was calculated from a Fourier transform signal obtained by performing a frequency analysis using the technique of Fourier transform on the difference spectrum. Alternatively, it is possible to perform a frequency analysis using a maximum entropy method (MEM), which has become frequently used in recent years for frequency analyses in place of the Fourier transform method.

Instead of the frequency analysis, a phase detection method based on equation (8) may be performed as follows: In the Fourier transform signal shown in graph (j) of FIG. 5, the signal corresponding to the optical path length d has a width of approximately 20 μm, which is the reciprocal of the spectrum width of the light source 1, i.e. 15 nm. Although the use of the maximum entropy method in place of the Fourier transform in the frequency analysis enables the estimation of frequency signals of narrower widths, it is nevertheless difficult to achieve an accuracy of 0.1 μm or finer by the frequency analysis. This difficulty can be overcome by the following method, which pays attention to the phase of the difference spectrum shown in graph (i) of FIG. 5: In graph (i), the zero-crossing point (i.e. the point where the interference amplitude is zero) is λ=800 nm. In equation (8), when constant k is set as k=101±1 so that the optical path length for the measurement will be d=20.3 μm, the change in the distance is λ_{c}=0.2 μm, the zero-crossing point is λ=0.8 μm, and the measurement wavelength is λ_{c}=0.8 μm. In this case, the optical path length d takes one of the three values of d=20.10 μm (k=100), d=20.30 μm (k=101) and d=20.50 μm (k=102); it can neither be 20.25 μm nor d=20.35 μm. In this manner, by detecting the phase of the difference spectrum (interference pattern), it is possible to calculate the optical distance with higher resolutions than in the case of performing the frequency analysis.

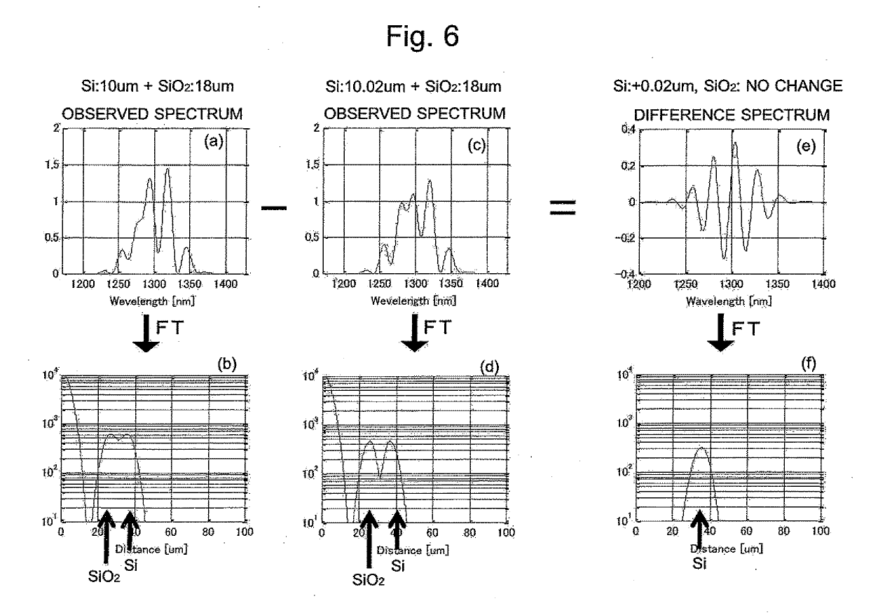

The previously described technique of the present invention can also be applied to the monitoring of the thickness of a substrate being ground, to cancel interference patterns originating from structures other than the target structure. One example of this application mode is hereinafter described by means of FIG. 6. FIG. 6 shows the result of a simulation of a measurement of silicon (Si) with a thickness of 10 μm including an 18-μm-thick silicon dioxide (SiO₂) layer being placed in a measurement path. To measure the Si thickness, a light source which emits light at 1300 nm, at which no absorption by Si occurs, was used. Graph (a) of FIG. 6 is a spectrum acquired when the grinding process has progressed to a level of 10 μm. The optical path length due to the 10-μm Si is 35 μm, while the same length due to the 18-μm SiO₂ layer is 27 μm. Since the two values are very close to each other, the two signals after the Fourier transform are located so close to each other that it is difficult to separate them. As shown in graph (b) of FIG. 5, it is very difficult to estimate the peak position corresponding to the plate thickness of Si by a normal Fourier analysis.

Even in such a case, a normalized spectrum as shown in graph (e) of FIG. 6, which does not include the interference pattern caused by the SiO₂ layer, can be created by merely calculating the difference spectrum using a spectrum shown in graph (c) of FIG. 6, which was acquired at a point in time earlier than the current point in time by a certain length of time when the surface being ground was at 10.02 μm in Si thickness. Subsequently, as in the previous example, a Fourier transform of the acquired spectrum can be performed to obtain a Fourier transform signal originating from only the Si layer, as shown in graph (f) of FIG. 6. From this signal, it is easy to determine the peak position and calculate the plate thickness of Si from that position.

It should be noted that the previous embodiments are mere examples of the present invention, and any change, addition or modification appropriately made within the spirit of the present invention will naturally fall within the scope of claims of the present patent application.

### EXPLANATION OF NUMERALS

1 . . . Light Source
2 . . . Measurement Optical System
21 . . . Entrance Optical Fiber
22 . . . Fiber Coupler
23 . . . Optical Fiber
24 . . . Collimator Lens
3 . . . Light-Dispersing Unit
31 . . . Diffraction Grating
32 . . . Array Detector
4 . . . Data Processor
41 . . . Spectrum Memory
42 . . . Difference Spectrum Calculator
43 . . . Fourier Transform Operator
44 . . . Optical Distance Calculator
5 . . . Sample
5A, 5B, 51 . . . Substrate
52 . . . Trench Hole
53 . . . Resist Layer
61-65 . . . Reflected Light

1. A surface processing progress monitoring system for measuring a size of a target structure, such as a depth or level difference of a hole or groove formed on a substrate by surface processing work, or a thickness of a thin layer or substrate increasing or decreasing due to the surface processing work, including a light source for generating a measurement light having a predetermined wavelength width, an interference optical system for producing interference of two lights respectively reflected by a first portion and a second portion of the target structure, a dispersing device for wavelength-dispersing an interference light produced by the interference optical system, and a detector for detecting, for each wavelength, a wavelength-dispersed light produced by the dispersing device, the surface processing progress monitoring system further comprising:
a) a spectrum acquiring section for acquiring, by the detector, two spectra of a predetermined wavelength range at two points in time separated by a short interval of time;
b) a difference spectrum calculating section for calculating a difference spectrum of the two spectra obtained by the spectrum acquiring section; and
c) a frequency analyzing section for performing a frequency analysis on the difference spectrum to calculate an interference distance of interest, and for determining the size of the target structure from the interference distance.

2. The surface processing progress monitoring system according to claim 1, wherein the frequency analysis performed by the frequency analyzing section is a Fourier transform operation.

3. The surface processing progress monitoring system according to claim 1, wherein the frequency analysis performed by the frequency analyzing section is an analysis by a maximum entropy method.

4. The surface processing progress monitoring system according to claim 1, further comprising an acquisition condition determining section for determining and setting an optimal value of the aforementioned short interval of time based on a magnitude of an amplitude of the difference spectrum.

5. The surface processing progress monitoring system according to claim 2, further comprising an acquisition condition determining section for determining and setting an optimal value of the aforementioned short interval of time based on a magnitude of an amplitude of the difference spectrum.

6. The surface processing progress monitoring system according to claim 3, further comprising an acquisition condition determining section for determining and setting an optimal value of the aforementioned short interval of time based on a magnitude of an amplitude of the difference spectrum.

7. The surface processing progress monitoring system according to claim 1, further comprising an acquisition condition determining section for determining and setting an optimal value of the aforementioned short interval of time based on an area of a region surrounded by the curve of the difference spectrum or on the change in the amplitude of the spectra.

8. The surface processing progress monitoring system according to claim 2, further comprising an acquisition condition determining section for determining and setting an optimal value of the aforementioned short interval of time based on an area of a region surrounded by the curve of the difference spectrum or on the change in the amplitude of the spectra.

9. The surface processing progress monitoring system according to claim 3, further comprising an acquisition condition determining section for determining and setting an optimal value of the aforementioned short interval of time based on an area of a region surrounded by the curve of the difference spectrum or on the change in the amplitude of the spectra.

10. A surface processing progress monitoring system for measuring a size of a target structure, such as a depth or level difference of a hole or groove formed on a substrate by surface processing work, or a thickness of a thin layer or substrate increasing or decreasing due to the surface processing work, including a light source for generating a measurement light having a predetermined wavelength width, an interference optical system for producing interference of two lights respectively reflected by a first portion and a second portion of the target structure, a dispersing device for wavelength-dispersing an interference light produced by the interference optical system, and a detector for detecting, for each wavelength, a wavelength-dispersed light produced by the dispersing device, the surface processing progress monitoring system further comprising:
a) a spectrum acquiring section for acquiring, by the detector, two spectra of a predetermined wavelength range at two points in time separated by a short interval of time;
b) a difference spectrum calculating section for calculating a difference spectrum of the two spectra obtained by the spectrum acquiring section; and
c) a phase analyzing section for detecting a phase of an interference pattern based on the difference spectrum, for calculating an interference distance of interest from the phase, and for determining the size of the target structure from the interference distance.

11. The surface processing progress monitoring system according to claim 10, further comprising an acquisition condition determining section for determining and setting an optimal value of the aforementioned short interval of time based on a magnitude of an amplitude of the difference spectrum.

12. The surface processing progress monitoring system according to claim 10, further comprising an acquisition condition determining section for determining and setting an optimal value of the aforementioned short interval of time based on an area of a region surrounded by the curve of the difference spectrum or on the change in the amplitude of the spectra.
